(19) United States
(12) Patent Application Publication
(10) Pub. No.: US 2006/0136909 A1
(43) Pub. Date: Jun. 22, 2006

(54) Methods and systems for providing software copy control

(76) Inventors: Arthur G. Davis, Counce, TN (US); Ruth A. Jones, Collierville, TN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/214,980

(22) Filed: Aug. 31, 2005

Related U.S. Application Data
(60) Provisional application No. 60/607,672, filed on Sep. 7, 2004.

(51) Int. Cl. G06F 9/445

(52) U.S. Cl. 717/177

(57) ABSTRACT

Systems and methods for providing software copy control. The disclosed systems and methods may include distributing an installation program. The installation program may be configured to extract identification information from a user processor designated to run an application program. The identification information may include one or more of a motherboard serial number associated with the user processor, a central processing unit serial number associated with the user processor, and a hard disk drive serial number associated with the user processor. Furthermore, the disclosed systems and methods may include receiving the identification information, receiving a request for the application program, and creating an identifier based on at least the received identification information. Moreover, the disclosed systems and methods may include transmitting the application program. The application program may be configured to be installed on the user processor by the installation program and the application program may be configured to run only on the user processor by using the identifier.

### RELATED APPLICATION

This application claims priority to U.S. Provisional Application No. 60/607,672 filed on Sep. 7, 2004, the contents of which are expressly incorporated herein by reference.

### BACKGROUND

1. Technical Field

The present invention generally relates to providing software copy control. More particularly, the present invention relates to providing software copy control using, for example, identification information associated with a processor.

2. Background of the Invention

The United States Postal Service™ is an independent government agency that provides mail delivery and other services to the public. The U.S. Postal Service™ is widely recognized as a safe and reliable means for sending and receiving mail and other items. With the advent and steady growth of electronic mail and electronic commerce, the physical mail stream will increasingly be utilized for sending and receiving mail pieces, packages, and other items.

To facilitate products and services provided, many enterprises, including the U.S. Postal Service™, may provide data files and application programs to their customers, for example. However, these files and application programs may cost the enterprise a considerable amount of time and money to produce and may have unauthorized uses by the customer. Consequently, providing software copy control is desired. Great inefficiencies are created in conventional systems because, for example, they may not allow for a centralized processes for distributing and copy controlling software. Accordingly, providing improved software copy control is desired. Thus, there remains a need for efficiently providing software copy control. In addition, there remains a need for efficiently providing centralized processes for distributing and copy controlling software.

### SUMMARY

Consistent with embodiments of the present invention, systems and methods are disclosed for providing software copy control.

In accordance with one embodiment, a method for providing software copy control comprises distributing an installation program, the installation program configured to extract identification information from a user processor designated to run an application program, the identification information including at least one of a motherboard serial number associated with the user processor, a central processing unit serial number associated with the user processor, and a hard disk drive serial number associated with the user processor, receiving the identification information, receiving a request for the application program, creating an identifier based on at least the received identification information, and transmitting the application program, the application program configured to be installed on the user processor by the installation program and configured to run only on the user processor using the identifier.

In accordance with one embodiment, a method provides an application program designated to run on a single, identified processor. Such a method may include distributing an installation program configured to extract a unique code from the processor; receiving the unique code; creating an identifier based on at least the received unique code; and transmitting the application program, the application program configured to be installed on the processor by the installation program and configured, using the identifier, to run only on the processor.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary software copy control providing system consistent with an embodiment of the present invention; and

FIG. 2 is a flow chart of an exemplary method for providing software copy control consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with the invention may also provide software copy control. For example, embodiments of the invention may provide a public website for centrally managing licenses, products, and applications. This website may provide, for example, electronic keys to customers for activating application programs or data files that the customer has purchased or has been otherwise provided. This website may also, for example, facilitate managing customer licenses and license renewals. An enterprise operating such a website may realize revenue that may have been lost due to unauthorized copying of products and applications.

An embodiment consistent with the invention may comprise a system for providing software copy control. The system may comprise a memory storage for maintaining a database and a processing unit coupled to the memory storage. The processing unit may be operative to distribute an installation program. The installation program may be configured to extract identification information from a user processor designated to run an application program. The identification information may include, for example, one or more of a motherboard serial number associated with the user processor, a central processing unit serial number associated with the user processor, or a hard disk drive serial number associated with the user processor. Moreover, the processing unit may be operative to receive the identification information, receive a request for the application program, and create an identifier based on at least the received identification information. Furthermore, the processing unit may be operative to transmit the application program. The application program may be configured to be installed on the user processor by the installation program and configured to run only on the user processor using the identifier.

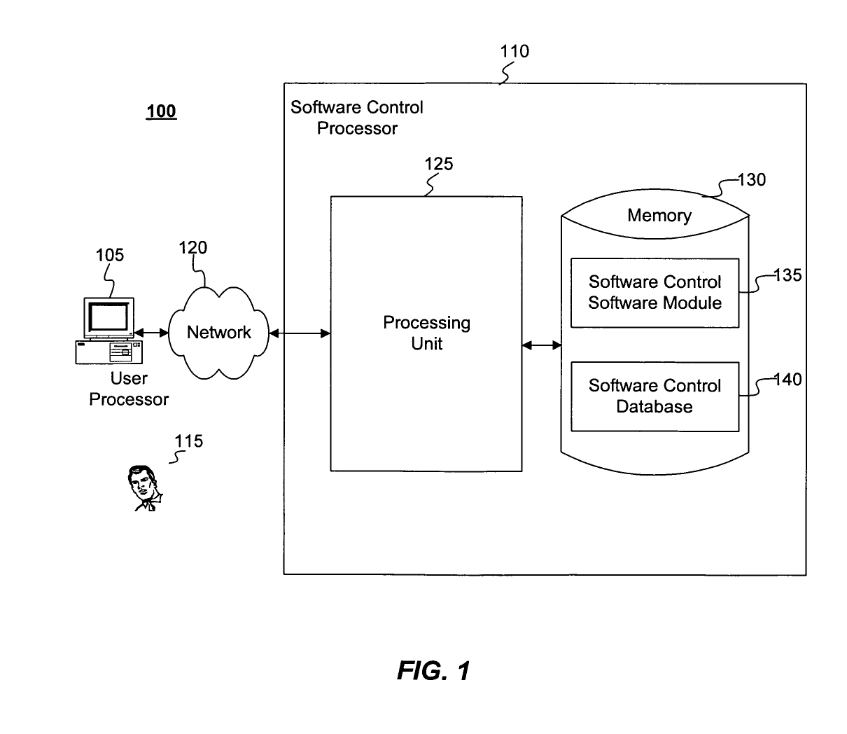

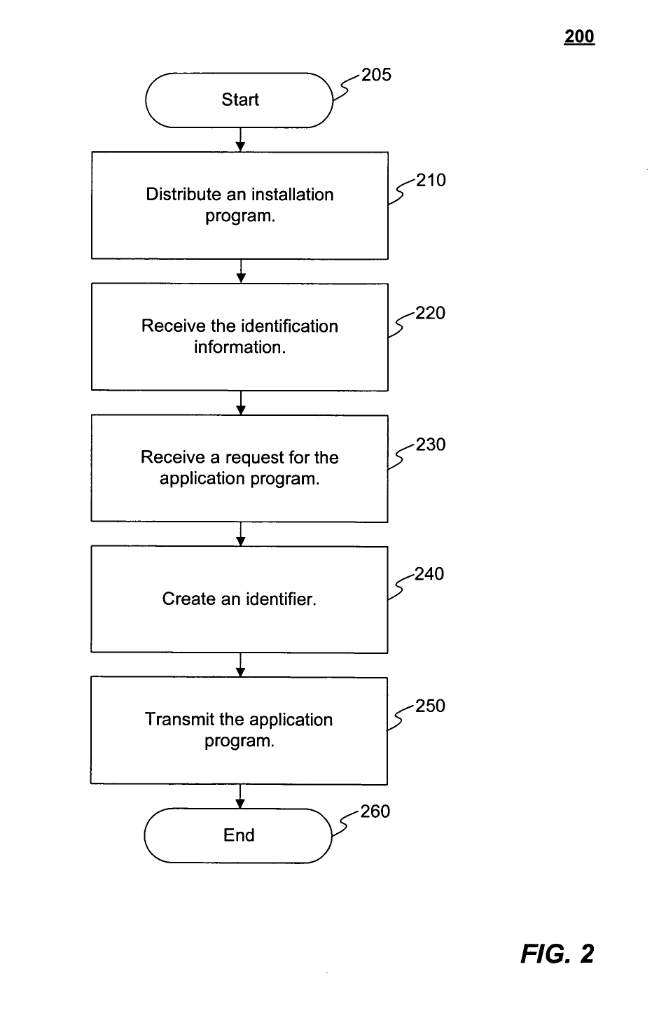

Consistent with an embodiment of the present invention, the aforementioned memory, processing unit, and other components may be implemented in a software copy control providing system, such as an exemplary system 100 of FIG. 1. Any suitable combination of hardware, software and/or firmware may be used to implement the memory, processing unit, or other components. By way of example, the memory, processing unit, or other components may be implemented with any of a software control processor 110 or a user processor 105, in combination with system 100, as described below with respect to FIG. 1 and FIG. 2. The aforementioned system and processors are exemplary and other systems and processors may comprise the aforementioned memory, processing unit, or other components, consistent with embodiments of the present invention.

Furthermore, any system or component of the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

As shown in FIG. 1, processor 110 may comprise a memory storage 130 for maintaining a database and a processing unit 125 coupled to the memory storage 130. Memory storage 130, processing unit 125, or other components of the processor 110 may be implemented in combination with system 100. The aforementioned system and processor are exemplary and other systems and processors may comprise the aforementioned memory, processing unit, or other components, consistent with embodiments of the present invention.

As illustrated in the block diagram of FIG. 1, system 100 may include a user 115, processors 105 and 110, and a network 120. Processor 110 may include processing unit 125 and memory 130. Memory 130 may include a software control software module 135 and a software control database 140. For example, software module 135, executed on processing unit 125, may access database 140 and implement processes for providing software copy control such as the method described below with respect to FIG. 2.

Processors 105 and 110, or any other processor or component included in system 100 (“the processors”), may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, intranets, and the Internet, and are known by those skilled in the art. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit data by methods and processes other than, or in combination with, network 120. These methods and processes may include, but are not limited to, transferring data via, diskette, CD ROM, flash memory sticks, facsimile, conventional mail, an interactive voice response system (IVR), or via voice over a publicly switched telephone network.

FIG. 2 is a flow chart setting forth the general stages involved in an exemplary method 200 consistent with the invention for providing software copy control using system 100 of FIG. 1. Exemplary ways to implement the stages of exemplary method 200 will be described in greater detail below.

Exemplary method 200 may begin at starting block 205 and proceed to stage 210 where software control processor 110 may distribute an installation program. For example, user 115 may receive the installation program at user processor 105 from software control processor 110 over network 120. Alternatively, user 115 may receive the installation program in, for example, any manner including those described above. The installation program may be configured to extract identification information from user processor 105, which may be designated by user 115 to run an application program. The identification information may include, for example, a motherboard serial number associated with user processor 105, a central processing unit serial number associated with user processor 105, or a hard disk drive serial number associated with user processor 105. The aforementioned identification information is exemplary and other information may be used.

From stage 210, where software control processor 110 distributes the installation program, exemplary method 200 may advance to stage 220 where software control processor 110 may receive the identification information. For example, once executed on user processor 105, the installation program may collect the identification information from user processor 105. Once collected, user processor 105 may send the collected identification information to software control processor 110 over network 120. Then exemplary method 200 may continue to stage 230 where software control processor 110 may receive a request for the application program. For example, user 115 may send a request to receive the application program from user processor 105 over network 120.

After software control processor 110 receives the request for the application program in stage 230, exemplary method 200 may proceed to stage 240 where software control processor 110 may create an identifier. The identifier may be based on at least the received identification information. For example, software control software module 135 may receive and process the identification information to create the identifier. The identifier may include information in addition to and/or other than the identification information. The identifier may be encoded within the application program in a manner that discourages easy identification or alteration. Indeed, the identifier may be encrypted within the application program.

Based on the created identifier, software module 135 may configure the application program to run only on a processor having identification corresponding to the identification information contained in the identifier. For example, the application program will only run on a processor having a motherboard, central processor, or hard disk drive corresponding to the identification. In this example, if the identification information corresponds to user processor 105, then software module 135 may configure the application program to run only on user processor 105.

From stage 240, where software control processor 110 creates the identifier, exemplary method 200 may advance to stage 250 where software control 110 processor may transmit the application program. Prior to transmitting the application program, the application program may be configured to be installed on user processor 105 by the installation program executed on user processor 105. Furthermore, as stated above, the application program may be configured by software module 135 to run only on user processor 105 using the identifier. After software control processor 110 transmits the application program in stage 250, exemplary method 200 may then end at stage 260.

After receiving the application program, the user installs the application program on the user processor 105. The application program may be configured to use the identifier to confirm that user processor 105 is the processor designated to run the application program. Using the identifier, for example, the application program may determine that it can run on a processor having a particular motherboard identification number. Each time a user runs the application program, the application program, as part of its initialization routine, determines the identification number of the processor. The application program then compares the determined identification number to the identification number within the identifier. For example, the application program may check to see if user computer 105's mother board identification number matches a number designated by the identifier. If the match is positive, then the application program may continue to execute on user processor 105. If the match is not positive, then the application program may stop execution.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing software copy control, the method comprising:
distributing an installation program, the installation program configured to extract identification information from a user processor designated to run an application program, the identification information including at least one of a motherboard serial number associated with the user processor, a central processing unit serial number associated with the user processor, or a hard disk drive serial number associated with the user processor;
receiving the identification information;
receiving a request for the application program;
creating an identifier based on at least the received identification information; and
transmitting the application program, the application program configured to be installed on the user processor by the installation program and configured, using the identifier, to run only on the user processor.

2. The method as claimed in claim 1, wherein distributing the installation program includes generating a computer readable media containing the installation program.

3. The method as claimed in claim 2, wherein the computer readable media is an optical disk.

4. The method as claimed in claim 2, wherein the computer readable media is a solid state memory.

5. The method as claimed in claim 1, wherein distributing the installation program includes transmitting the installation program over a network.

6. The method as claimed in claim 5, wherein the network comprises the Internet.

7. A method for providing an application program designated to run on a single, identified processor, comprising:
distributing an installation program configured to extract a unique code from the processor;
receiving the unique code;
creating an identifier based on at least the received unique code; and
distributing the application program, the application program configured to be installed on the processor by the installation program and configured, using the identifier, to run only on the processor.

8. The method according to claim 7, wherein the unique code comprises a motherboard serial number associated with the processor.

9. The method according to claim 7, wherein the unique code comprises a central processing unit serial number associated with the processor.

10. The method according to claim 7, wherein the unique code comprises a hard disk drive serial number associated with the processor.

11. The method as claimed in claim 7, wherein distributing the installation program includes generating a computer readable media containing the installation program.

12. The method as claimed in claim 11, wherein the computer readable media is an optical disk.

13. The method as claimed in claim 11 wherein the computer readable media is a solid state memory.

14. The method as claimed in claim 7, wherein distributing the installation program includes transmitting the installation program on a network.

15. The method as claimed in claim 14, wherein the network comprises the Internet.

16. The method as claimed in claim 7, wherein distributing the application program includes transmitting the application program over a network.

17. The method as claimed in claim 16, wherein the network comprises the Internet.

18. A method of installing an application program from a program supplier, the application program being designated to run on a single, identified processor, comprising:
receiving an installation program configured to extract a unique code from the processor;
extracting the unique code from the processor;
sending the unique code to the program supplier; and
receiving the application program, the application program configured to be installed on the processor by the installation program and configured, using an identifier included within the application program, to run only on the processor, the identifier being based on at least the unique code.

19. The method as claimed in claim 18, further comprising comparing the identifier to the unique code.

20. The method according to claim 18, wherein the unique code comprises a motherboard serial number associated with the processor.

21. The method according to claim 18, wherein the unique code comprises a central processing unit serial number associated with the processor.

22. The method according to claim 18, wherein the unique code comprises a hard disk drive serial number associated with the processor.
